(19) United States
(12) Patent Application Publication
(10) Pub. No.: US 2009/0223755 A1
(43) Pub. Date: Sep. 10, 2009

(54) VEHICLE BRAKE WITH AN ELECTROMECHANICAL DRIVE

(75) Inventors: Wilfried Giering, Mendig (DE); Benedikt Ohlig, Vallendar (DE); Gregor Poertzgen, Koblenz (DE)

Correspondence Address: MACMILLAN SOBANSKI & TODD, LLC, ONE MARITIME PLAZA FIFTH FLOOR, 720 WATER STREET, TOLEDO, OH, 43604-1619, US

(73) Assignee: LUCAS AUTOMOTIVE GMBH, Koblenz (DE)

(21) Appl. No.: 12/399,262

(22) Filed: Mar. 6, 2009

(30) Foreign Application Priority Data
Mar. 6, 2008 (DE) DE102008012917.8
Jul. 15, 2008 (DE) DE102008033263.1

(51) Int. Cl. F16D 65/21

(52) U.S. Cl. 188/156

(57) ABSTRACT

A vehicle brake with an electromechanical drive, by means of which electrical energy fed into a brushless direct current motor is converted into mechanical energy to generate braking forces, the electrical energy being fed via an electronic control unit into the electric motor.

### CROSS-REFERENCE TO RELATED APPLICATIONS

This application claims priority to German Patent Application No. 10 2008 012 917.8 filed Mar. 6, 2008, the disclosures of which are incorporated herein by reference in their entirety, and German Patent Application No. 10 2008 033 263.1 filed Jul. 15, 2008, the disclosures of which are incorporated herein by reference in their entirety.

### BACKGROUND OF THE INVENTION

The invention concerns a vehicle brake with an electromechanical drive, by means of which electrical energy which is fed into an electric motor is converted into mechanical energy to generate braking forces, the electrical energy being fed via an electronic control unit into the electric motor.

In the prior art, such a vehicle brake is known from, among other places, DE 197 32 168 C2, and corresponding U.S. Pat. No. 6,394,235 B1, both of which are incorporated by reference herein, and DE 198 07 328 C2, and corresponding U.S. Pat. No. 6,349,801 B1, both of which are incorporated by reference herein. These known vehicle brakes each have an electromechanical drive, which contains an electric motor, the rotation of which is converted to linear motion by means of a spindle-nut gear. The linear motion is transmitted to friction elements of the vehicle brake, to generate braking forces. The electrical energy which is fed via an electronic control unit into the electric motor is converted into mechanical energy. In the case of the vehicle brake which is known from DE 198 07 328 C2, this is a purely electromechanical brake (EMB), where the functions of both the service brake and the parking brake take place electromechanically. In contrast, the vehicle brake which is known from DE 197 32 168 C2 is an electrical parking brake (EPB), where only the function of the parking brake takes place electromechanically, whereas for the function of the service brake, conventional hydraulic activation is provided.

### BRIEF SUMMARY OF THE INVENTION

The invention is based on the object of providing electrically improved engineering for a vehicle brake as mentioned above.

To achieve the object, it is proposed that the electric motor is a brushless direct current (BLDC) motor.

A brushless direct current motor involves a reversal of the construction of a conventional direct current motor, since the rotatably carried part—rotor—consists of permanent magnets, and the fixed part—stator—consists of several magnet coils. The brushes which are otherwise usual for a sliding contact are therefore omitted in the case of a brushless direct current motor, so that unlike a conventional direct current motor, no spark formation occurs on the brushes. Because this spark formation, also called brush fire, is the main cause of the very frequent interference which a conventional direct current motor feeds back into the vehicle electrical system and which interferes with the other electrical loads. Additionally, brush fire not only limits the maximum rotational speed, since the brushes become hot at high rotational speeds, but also causes very high brush wear, which has a negative effect on the efficiency, reliability and lifetime of the vehicle brake. A brushless direct current motor avoids all these disadvantages.

Above all because a brushless direct current motor causes almost no interference, it can be specially advantageously provided that the electronic control unit consists of at least two control components, of which a first control component is an integral part of the vehicle brake. Because of the integration of the first control component into the vehicle brake, the vehicle brake can follow the principle of a so-called “smart” actuator, as described in DE 10 2004 059 546 A1, the first control component co-operating with the other control components of the electronic control unit by data exchanges via a communication or bus system such as CAN (controller area network) or LIN (local interconnect network).

Because the vehicle brake is in the form of a “smart” actuator, there is the further advantage that the first control component can include electronic circuits for commutating the electric motor. Because of the omission of the brushes, in the case of a brushless direct current motor electronic commutation is necessary. To do this, the magnet coils of the stator, comprising several—often three-phases, are usually commutated via a bridge circuit with semiconductor switching elements, e.g. transistor, MOSFET (metal oxide semiconductor field effect transistor), IGBT (insulated gate bipolar transistor), which can also be integrated in an IC (integrated circuit). In the case of a three-phase version of the magnet coils for driving 120 electronic degrees, this means that an electrical connection between the electric motor and the electronic commutation consisting of three, or if the star point is connected even four, lines is necessary. Because of the integration of the electronic commutation into the first control component, in the direct spatial vicinity, this connection occurs so to speak “by the shortest path on site”, so that a high cost of electrical connection is not required and high security from interference is ensured.

A further advantage is that the first control component can include electronic circuits for regulating the speed and direction of rotation of the electric motor, so that these too are arranged in the direct spatial vicinity of the electric motor. There is thus very good power and signal transmission, which makes highly dynamic regulation of the electric motor or vehicle brake possible, which is very important for an anti-lock braking system (ABS), for instance.

The electric motor can be a sensorless brushless direct current motor, with which no separate sensors for capturing the rotor position or rotational speed are required. Since the rotor position must be known to regulate the slip between the rotational speed of the rotary field of the stator and the actual rotational speed of the rotor, the counter-voltage or counter-electromotive force is often used. For this purpose, in the case of a three-phase version, current is only ever supplied to two magnet coils simultaneously, whereas one magnet coil always remains without current; the voltage which is induced by the rotation of the rotor in a magnet coil without current is then used to determine the rotor position.

However, it can also be provided that the electric motor is a sensor-controlled brushless direct current motor, which has sensors to capture the rotor position, so that the phases can be regulated depending on the rotor position. This makes specially precise regulation of the electric motor possible, and thus very sensitive and jerk-free operation of the vehicle brake, resulting in high braking comfort, which is important in the case of automatic cruise control (ACC), for instance. As sensors, among others magnetic, electrical or optical sensors, e.g. Hall sensors, potentiometers or incremental transducers, are used. With integration of the first control component into the vehicle brake, the result is also the above-mentioned advantage that the sensors are electrically connected in the direct spatial vicinity, so that the cost of electrical connection is kept low and very good signal transmission and high security from interference are ensured.

Other advantages of this invention will become apparent to those skilled in the art from the following detailed description of the preferred embodiments, when read in light of the accompanying drawing.

### BRIEF DESCRIPTION OF THE DRAWING

FIG. 1 is a schematic illustration of the structure of a vehicle brake having an electromechanical drive that contains an electric motor in accordance with the present invention.

### DETAILED DESCRIPTION OF THE INVENTION

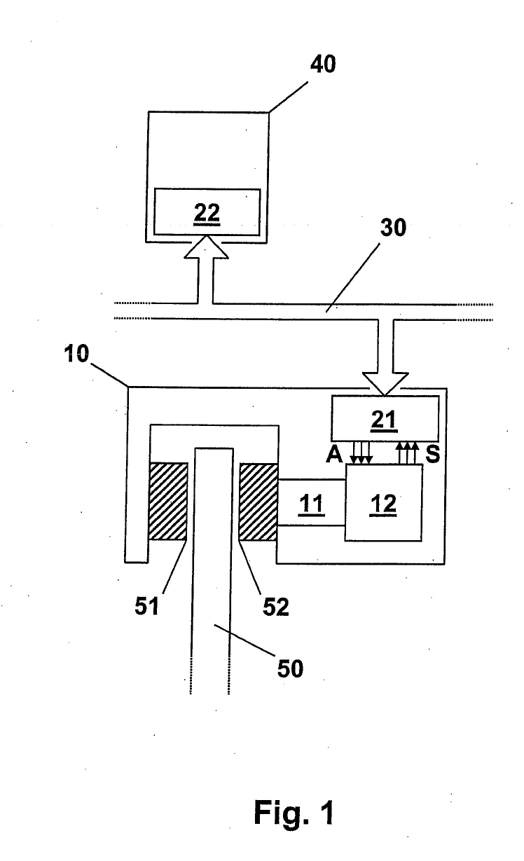

In the drawing FIG. 1, the structure of a vehicle brake 10 is shown schematically. The vehicle brake 10 has an electromechanical drive, which contains an electric motor 12, the rotation of which is converted to linear motion by means of a spindle-nut gear 11. The linear motion is transmitted to brake pads 51 and 52, which work with a brake disc 50, so that the electrical energy which is fed into the electric motor 12 is converted into mechanical energy, to generate braking forces.

The electrical energy is fed into the electric motor 12 via an electronic control unit, which consists of a first control component 21 and a second control component 22. The control components 21 and 22 are not arranged centrally, so that they are housed at different fitting locations in the vehicle.

The first control component 21 is an integral part of the vehicle brake 10, which means that the first control component 21 is arranged within the housing of the vehicle brake 10 or in a separate housing, which is arranged directly on the housing of the vehicle brake 10. The first control component 21 also includes the electronic circuits (not shown in more detail) for commutating and regulating the speed and direction of rotation of the electric motor 12. It is essential that the electric motor 12 can be connected electrically to the first control component 21 “by the shortest path on site”. In the case of a sensor-controlled brushless direct current motor, these are the electrical lines and/or the wiring loom for transmitting the control signals A and sensor signals S. This cable loom would have to be placed separately in the vehicle if the first control component 21 was not an integral part of the vehicle brake 10, so that high susceptibility to interference would be added to the high cabling cost.

The first control component 21 acts with the second control component 22 via a communication system 30, in such a way that on the one hand it receives the control commands for operating the vehicle brake 10, and on the other hand it reports back the operating states of the vehicle brake 10. The second control component 22 is associated with a system unit 40, which can be an input unit, a pedal device, switch device or button device, via which the driver transmits the wish to operate the vehicle brake, or a control unit, e.g. the electronic controller of the service braking system. Other control components such as an electronic engine power controller and an electronic steering system (not shown in more detail) are connected to the communication system 30.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. A vehicle brake comprising:
an electromechanical drive that includes a brushless direct current motor; and
an electronic control unit for feeding electrical energy into the electric motor with the electromechanical drive operable to convert the electrical energy fed into the electric motor into mechanical energy to generate braking forces.

2. The vehicle brake according to claim 1, wherein the electronic control unit consists of at least two control components, of which a first control component is an integral part of the vehicle brake.

3. The vehicle brake according to claim 2, wherein the first control component includes electronic circuits for commutating the electric motor.

4. The vehicle brake according to claim 3, wherein the first control component also includes electronic circuits for regulating the speed and direction of rotation of the electric motor.

5. The vehicle brake according to claim 4 wherein the electric motor is disposed within a housing and further wherein the first control component also is disposed within the housing.

6. The vehicle brake according to claim 4 wherein the electric motor is disposed within a housing and further wherein the first control component is arranged directly upon the housing.

7. The vehicle brake according to claim 5 wherein the electric motor is a sensor-controlled brushless direct current motor.

8. The vehicle brake according to claim 2, wherein the first control component includes electronic circuits for regulating the speed and direction of rotation of the electric motor.

9. The vehicle brake according to claim 1, wherein the electric motor is a sensor-controlled brushless direct current motor.
